(19) United States
(12) Patent Application Publication
(10) Pub. No.: US 2018/0328327 A1
(43) Pub. Date: Nov. 15, 2018

(54) CONNECTION ARRANGEMENT COMPRISING A HYDRAULIC CONNECTION ELEMENT

(71) Applicant: Robert Bosch GmbH, Stuttgart (DE)

(72) Inventor: Klaus Lang, Stuttgart (DE)

(73) Assignee: Robert Bosch GmbH, Stuttgart (DE)

(21) Appl. No.: 15/525,702

(22) PCT Filed: Sep. 18, 2015
(86) PCT No.: PCT/EP2015/071443

§ 371 Date: May 10, 2017

(30) Foreign Application Priority Data
Nov. 12, 2014 (DE) 102014223063.2

(51) Int. Cl. F02M 55/00; F02M 61/16

(52) U.S. Cl. CPC F02M 55/005; F02M 61/168

(57) ABSTRACT

A connecting assemblage includes a connecting element and a hydraulic connecting piece, between which a seal is embodied. The hydraulic connecting element has a main body that has a tubular piece and a tulip adjoining the tubular piece. An axial opening is provided through which a hydraulic medium, which is guidable via the tubular piece via the tulip, is guidable out of the tulip of the main body. The main body is configured at the axial opening so that during operation, a pressure drop in the hydraulic medium is achieved via the axial opening.

### FIELD OF THE INVENTION

The present invention relates to a hydraulic connecting element that serves in particular for devices on internal combustion engines, and to a connecting assemblage having such a hydraulic connecting element and a hydraulic connecting piece, between which a seal is ensured.

### BACKGROUND INFORMATION

Patent document DE 10 2007 019 464 A1 discusses a sealing apparatus for a fuel line connector. The sealing apparatus has a connector element of a fuel line and a receiving element for that connector element. Also provided in this context is a sealing element sleeve that is disposed between the connector element and the receiving element. The connector element possesses a ball element having an axial passthrough conduit.

The sealing apparatus discussed in DE 10 2007 019 464 A1 may have the disadvantage that additional components are necessary to implement hydraulic tuning. Hydraulic tuning of this kind, for example in an injection system, is necessary as a result of various requirements, for example, to minimize noise or protect components.

### SUMMARY OF THE INVENTION

The hydraulic connecting element according to the present invention having the features described herein, and the connecting assemblage according to the present invention having the features described herein, have the advantage that improved functionality is enabled. In particular, hydraulic tuning can be implemented at least in part via the geometric conformation of the hydraulic connecting element, with the result that additional components can be omitted.

Advantageous refinements of the hydraulic connecting element described herein, and of the connecting assemblage described herein, are possible thanks to the features set forth in the further descriptions herein.

The connecting assemblage having the hydraulic element can be utilized in particular in fuel injection systems of internal combustion engines. Hydraulic components such as pumps, pressure reservoirs, and fuel injection valves can be connected in this context by way of hydraulic lines. Hydraulic connecting elements can be mounted or configured on the hydraulic lines. A hydraulic connecting element can be manufactured, for example, from a tube preform at whose end a so-called “tulip” can be shaped on without machining. This manufacturing approach is particularly suitable for inexpensively manufacturing connecting lines having connecting elements configured thereon. This connection using a connecting piece can be accomplished via a fastening arrangement in order to preload the connection. Depending on the configuration of the connecting element, however, the connection can also be accomplished without such an additional fastening arrangement.

Other applications for the connecting assemblage having the hydraulic connecting element are, however, also conceivable. In the sector of devices on internal combustion engines, another possible application is metering of an additive in order to improve exhaust behavior.

The hydraulic systems, for example in the injection systems, can be hydraulically optimized in terms of shape due to various requirements, for example minimization of noise or protection of components, in such a way that the lengths and inside diameters are specifically tuned. An optimization is also accomplished according to the present invention by way of the conformation of the main body at the axial opening. The axial opening can be configured as an orifice or throttle. Sub-regions can thereby be hydraulically decoupled. An orifice is notable for a short length, resulting in a small pressure drop. A throttle, conversely, is notably for a greater length, resulting in a large pressure drop. It is also noteworthy here that with the orifice, ideally the volume flow firstly increases with the pressure drop at the orifice and is then limited at least approximately to a maximum value, whereas with a throttle the volume flow increases at least approximately in proportion to the pressure drop at the throttle.

The advantage here is that an orifice or throttle of this kind can be implemented via the axial opening of the main body, so that an additional component is not required in this regard. Possible machining-based manufacture of an orifice or throttle of this kind in the connecting piece, which is conceivable in principle, can thus be omitted.

An additional component or additional machining can thus be dispensed with. This simplification allows the connecting assemblage to be manufactured more inexpensively.

It is thus advantageous that the main body is configured at the axial opening as an orifice. The orifice can be configured in such a way that a fractional value having a dividend that is a length of the axial orifice at the axial opening, and a divisor that is an average diameter of the orifice, is less than approximately 1.5.

It is nevertheless also advantageous that the main body is embodied at the axial opening as a throttling tubular extension. A throttle may then be formed by the throttling tubular extension. It is furthermore advantageous that a circumferential sealing edge, or an annularly continuous elastic sealing element, is provided on an end face of the tubular extension. This makes it possible in particular to reduce the diameter of the seal.

It is also advantageous in this context that an axial abutment point is predefined on the tulip; and that an axial distance between the axial abutment point that is provided on the tulip and the end face of the tubular extension is set by a elastic and/or plastic deformation of the tubular extension. In one possible configuration, the circumferential sealing edge on the tubular extension is configured as a bite-type edge. By way of the axial distance that is set it is then also possible to set the pressure with which the bite-type edge is pressed against the end face, so that the bite-type edge presses into the end face. In another possible embodiment the preload of the elastic sealing element can also be predefined by way of the axial distance that is set.

In another possible embodiment it is advantageous that a sealing ring, which in the assembled state is disposed on an outer side of the throttling extension, is provided. A circumferential groove, into which the sealing ring is partly inserted in the assembled state, can be configured in a bore of the hydraulic connecting piece. Advantageous sealing can thereby be achieved with a small-diameter seal. In addition, a circumferential groove of this kind can be configured in the bore in a comparatively non-complex manner.

It is advantageous that an average inside diameter at the axial opening is selected from a range of approximately 0.5 mm to approximately 1.8 mm. This configuration is advantageous especially in the context of implementing the pressure drop via an orifice.

It is also advantageous that a fractional value having a dividend that is an average inside diameter at the axial opening, and a divisor that is an average inside diameter of the tubular piece, is no greater than 0.5. Advantageous hydraulic conditions result therefrom.

Exemplifying embodiments of the invention are explained in further detail in the description below with reference to the appended drawings, in which corresponding elements are labeled with matching reference characters.

### BRIEF DESCRIPTION OF THE DRAWINGS

FIG. 1 depicts, in a schematic axial section, a connecting assemblage having a hydraulic connecting element, corresponding to a first exemplifying embodiment of the invention.

FIG. 2 shows the connecting assemblage depicted in FIG. 1, corresponding to a second exemplifying embodiment of the invention.

FIG. 3 shows the connecting assemblage depicted in FIG. 1, corresponding to a third exemplifying embodiment of the invention.

FIG. 4 shows the portion labeled IV in FIG. 3, corresponding to a possible configuration of the invention.

FIG. 5 shows the portion labeled IV in FIG. 3, corresponding to a further possible configuration of the invention.

### DETAILED DESCRIPTION

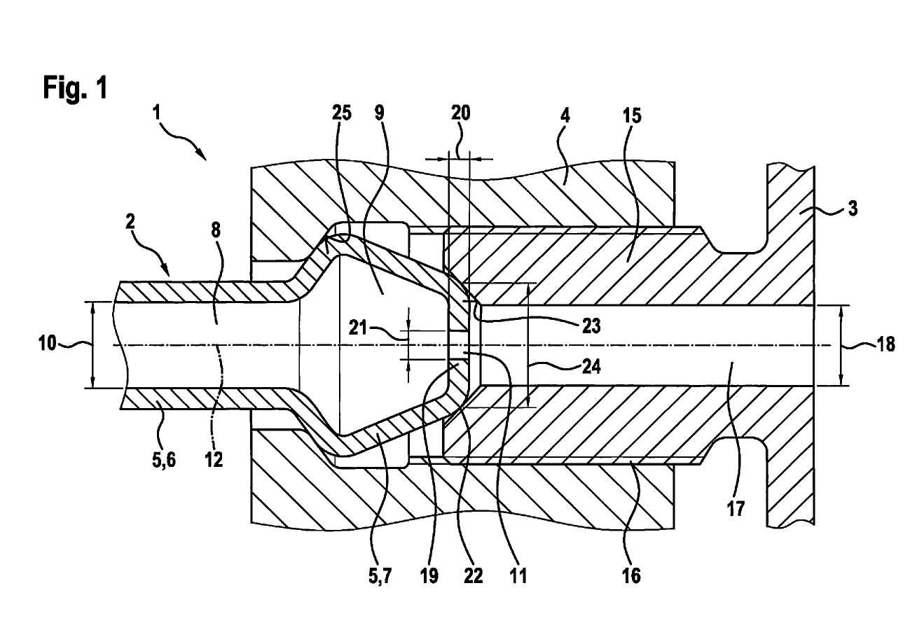

FIG. 1 depicts, in a schematic axial section, a connecting assemblage 1 having a hydraulic connecting element 2 and a hydraulic connecting piece 3, corresponding to a first exemplifying embodiment. Also provided in this exemplifying embodiment is a fastening arrangement 4 for preloading the connection.

Connecting assemblage 1 is suitable especially for devices on internal combustion engines. In particular, a fuel can be guided via hydraulic connecting element 2 and hydraulic connecting piece 3. Connecting assemblage 1 is also suitable, however, for other applications in which a hydraulic medium is utilized.

Hydraulic connecting element 2 has a main body 5 having a tubular piece 6 and a tulip 7 adjoining tubular piece 6. Upon manufacture, tulip 7 can be shaped in suitable fashion from a tubular main body 5. Embodied in tubular piece 6 is a conduit 8, configured as a bore 8, adjoining which is an inner space 9 of tulip 7. Bore 8 has an inside diameter 10. An axial opening 11, which is located on an axis 12 of main body 5, is also provided on tulip 7 of main body 5.

Hydraulic connecting piece 3 has a tubular piece 15. Tubular piece 15 has, in this exemplifying embodiment, an external thread 16 onto which fastening arrangement 4 is screwed. A conduit configured as a bore 17 is embodied on hydraulic connecting piece 3. Bore 17 has an inside diameter 18.

In this exemplifying embodiment, both bore 8 of hydraulic connecting element 2 and bore 17 of hydraulic connecting piece 3 are aligned on axis 12.

Main body 5 is configured at axial opening 11 in such a way that during operation, a pressure drop in the hydraulic medium is achieved via the axial opening. The hydraulic medium can be guided via tubular piece 6 into tulip 7, and out of tulip 7 through axial opening 11 into bore 17 of tubular piece 15. Main body 5 can be configured at axial opening 11 as an orifice 19.

Orifice 19 can in particular be configured so that a fractional value having a dividend that is a length 20 of orifice 19 at axial opening 11, and a divisor that is an average diameter 21 of orifice 19, is less than approximately 1.5.

In this exemplifying embodiment a seal 22 is embodied between tulip 7 and a conical abutment surface 23 of tubular piece 15. A diameter 24 of this seal 22 is larger than inside diameter 18 of bore 17 of tubular piece 15. In this exemplifying embodiment, diameter 24 of seal 22 is furthermore larger than inside diameter 10 of tubular piece 6 of connecting element 2, but this is not obligatorily necessary.

Tulip 7 furthermore abuts against a support surface 25 of fastening arrangement 4, tulip 7 being applied against conical abutment surface 23 of tubular piece 15, via support surface 25 of fastening arrangement 4, in such a way that seal 22 is established to achieve the necessary sealing.

Inside diameter 10 of tubular piece 6 of connecting element 2, and inside diameter 18 of tubular piece 15 of connecting piece 3, can be predefined to be at least approximately of the same size.

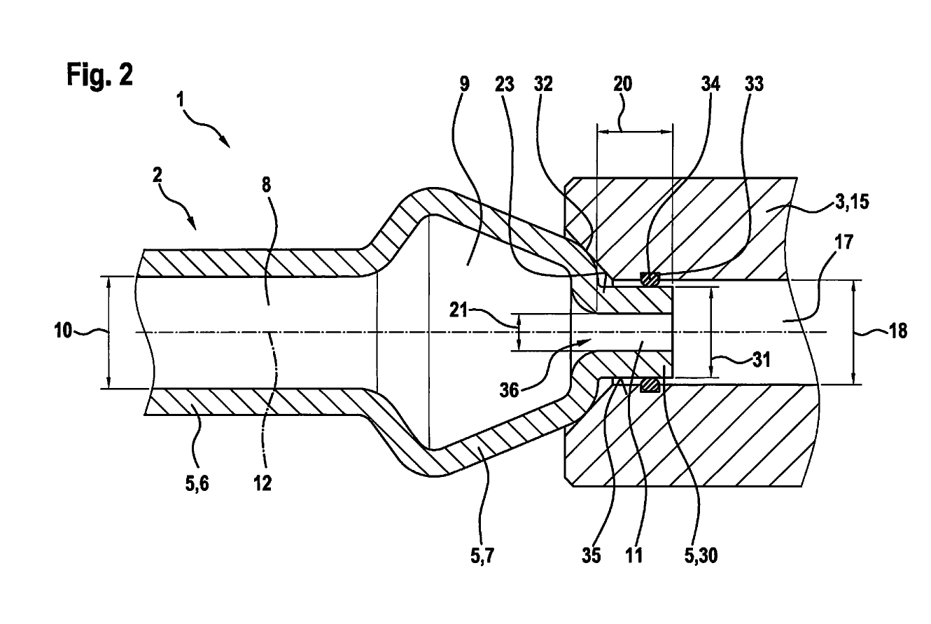

FIG. 2 shows the connecting assemblage depicted in FIG. 1, corresponding to a second exemplifying embodiment. In this exemplifying embodiment fastening arrangement 4 can be omitted or can have smaller dimensions, since a diameter of the seal is smaller. External thread 16 on tubular piece 15 can then also be omitted.

In this exemplifying embodiment, main body 5 of hydraulic connecting element 2 is embodied at axial opening 11 as a throttling tubular extension 30. A diameter 21 of axial opening 11 is both smaller than inside diameter 10 of tubular piece 6 and smaller than inside diameter 18 of tubular piece 15. In addition, an outside diameter 31 of tubular extension 30 is smaller than inside diameter 18 of tubular piece 15 and also smaller than inside diameter 10 of tubular piece 6.

In this exemplifying embodiment a stop 32, which abuts against conical abutment surface 23 of connecting piece 3 in the assembled state and during operation, is embodied on tulip 7.

In addition, a circumferential groove 33, into which a sealing ring 34 is inserted, is configured on bore 17 of connecting piece 3. Sealing ring 34 is disposed, in the assembled state, on an outer side 35 of throttling extension 30, in which context a seal is produced on outside diameter 31 between sealing ring 34 and outer side 35. The hydraulic diameter of the seal can thereby be reduced as compared with hydraulic diameter 24 described with reference to FIG. 1. The fastening forces needed in order to achieve sealing can thereby be reduced. The connection can also be physically smaller. The hydraulic diameter of the seal can be at least approximately equal to inside diameter 18 of bore 17.

For the configuration of throttle 36 provided via axial opening 11, a fractional value having a dividend that is an average inside diameter 21 at axial opening 11, and a divisor that is an average inside diameter 10 of tubular piece 6, can be predefined to be no greater than 0.5. In addition, the average inside diameter 21 at axial opening 11 can be selected from a range of approximately 0.5 mm to approximately 1.8 mm. Corresponding dimensions can also be provided for a configuration as orifice 19, as described with reference to FIG. 1.

For the configuration as a throttle, length 20 is defined to be greater, in particular appreciably greater, than diameter 21 of axial opening 11. A large pressure drop is achieved in this context.

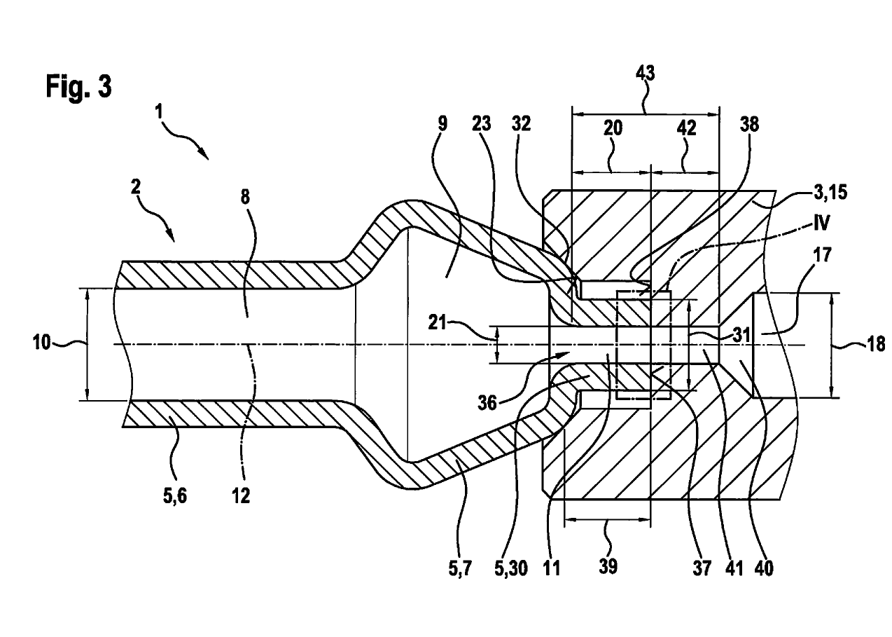

FIG. 3 shows connecting assemblage 1 depicted in FIG. 1, corresponding to a third exemplifying embodiment. In this exemplifying embodiment an axial abutment point 32 is formed by stop 32 of tulip 7. In the assembled state, axial abutment point 32 provided on tulip 7 abuts against conical abutment surface 23 of connecting piece 3. In addition, an end face 37 is embodied on tubular extension 30 and, in the assembled state, abuts against an abutment surface 38 of connecting piece 3. An axial distance 39 between axial abutment point 32 that is provided on tulip 7, and end face 37 of tubular extension 30, is set by way of a plastic deformation of tubular extension 30. The seal between end face 37 of tubular extension 30 and abutment surface 38 of connecting piece 3 is thereby established.

In this exemplifying embodiment, bore 17 is configured as a stepped bore 17 that transitions at a conical portion 40 from inside diameter 18 to the smaller diameter 21. Throttle 36 is then made up both of tubular extension 30 and of a portion 41 of stepped bore 17, such that portion 41 having diameter 21 extends over a length 42. A length 43 of throttle 36 is thus made up of length 20 of tubular extension 30 and length 42 of portion 41 of stepped bore 17. In this exemplifying embodiment, diameter 21 of throttle 36 is constant over the entire length 43.

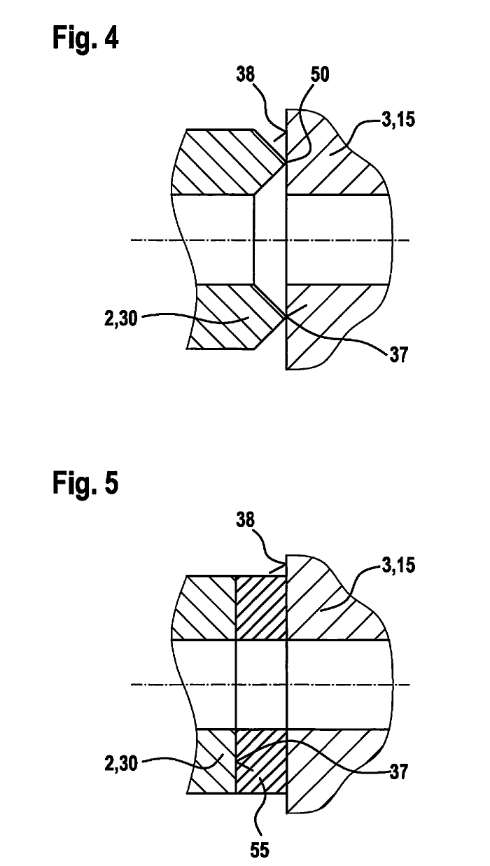

FIG. 4 shows the portion labeled IV in FIG. 3, corresponding to a possible embodiment of the invention. Here a circumferential sealing edge 50, which is pressed against abutment surface 38 of connecting piece 3, is configured at end face 37 of tubular extension 30. Circumferential sealing edge 50 can also be configured as a bite-type edge 50 that, in accordance with axial distance 39 that is set, cuts into abutment surface 38 in order to ensure sealing.

FIG. 5 shows the portion labeled IV in FIG. 3, corresponding to a further possible embodiment of the invention. In this exemplifying embodiment an annularly continuous elastic sealing element 55 is mounted on end face 37 of tubular extension 30 of connecting element 2. Elastic sealing element 55 can be constituted, for example, from a natural or synthetic rubber material or also from another elastic plastic. The preload on elastic sealing element 55 is set by way of axial distance 39 that is set. The seal at abutment surface 38 between tubular extension 30 of connecting element 2 and connecting piece 3 is thereby established.

The invention is not limited to the exemplifying embodiments described.

1-10. (canceled)

11. A hydraulic connecting element for a device on an internal combustion engine, comprising:
a main body having a tubular piece and a tulip adjoining the tubular piece, and an axial opening through which a hydraulic medium, which is guidable via the tubular piece into the tulip, is guidable out of the tulip of the main body;
wherein the main body is configured at the axial opening so that during operation, a pressure drop in the hydraulic medium is achieved via the axial opening.

12. The hydraulic connecting element of claim 11, wherein the main body is configured at the axial opening as an orifice.

13. The hydraulic connecting element of claim 12, wherein the orifice is configured so that a fractional value having a dividend that is a length of the orifice at the axial opening, and wherein a divisor, which is an average diameter of the orifice, is less than approximately 1.5.

14. The hydraulic connecting element of claim 11, wherein the main body is configured at the axial opening as a throttling tubular extension.

15. The hydraulic connecting element of claim 14, wherein one of a circumferential sealing edge and an annularly continuous elastic sealing element is on an end face of the tubular extension.

16. The hydraulic connecting element of claim 14, wherein an axial abutment point is predefined on the tulip, and wherein an axial distance between the axial abutment point that is on the tulip and the end face of the tubular extension is set by at least one of an elastic deformation and a plastic deformation of the tubular extension.

17. The hydraulic connecting element of claim 14, further comprising:
a sealing ring is disposed on an outer side of the tubular extension in an assembled state.

18. The hydraulic connecting element of claim 11, wherein an average diameter at the axial opening is in a range of approximately 0.5 mm to approximately 1.8 mm.

19. The hydraulic connecting element of claim 11, wherein a fractional value having a dividend that is an average diameter at the axial opening, and a divisor that is an average inside diameter of the tubular piece, is no greater than 0.5.

20. A connecting assemblage for a device on an internal combustion engines, comprising:
a hydraulic connecting element for a device on an internal combustion engine, including:
a main body having a tubular piece and a tulip adjoining the tubular piece, and an axial opening through which a hydraulic medium, which is guidable via the tubular piece into the tulip, is guidable out of the tulip of the main body, wherein the main body is configured at the axial opening so that during operation, a pressure drop in the hydraulic medium is achieved via the axial opening; and
a hydraulic connecting piece;
wherein a seal is configured between the hydraulic connecting element and the hydraulic connecting piece in an assembled state.
